(19) United States
(12) Patent Application Publication
(10) Pub. No.: US 2008/0257871 A1
(43) Pub. Date: Oct. 23, 2008

(54) Ablation device

(76) Inventors: Judson M. Leiser, Corvallis, OR (US); Cary G. Addington, Albany, OR (US); Michael French, Adair Village, OR (US); William Wren, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/788,806

(22) Filed: Apr. 20, 2007

(51) Int. Cl. B23K 26/38; B32B 33/00

(52) U.S. Cl. 219/121.67; 428/543

(57) ABSTRACT

Embodiments of an ablation device and an ablation process are disclosed.

### BACKGROUND

Ablation devices may be used to ablate a surface, such as a semiconductor substrate, during fabrication of a microelectronic device thereon. It may be desirable to ablate surfaces of a substrate having a large size.

### BRIEF DESCRIPTION OF THE DRAWINGS

FIG. 1 is a schematic view of one example embodiment of an ablation device.

FIG. 2 is a top view of one example embodiment of a set of ablation masks each defining a sub pattern.

FIG. 3 is a top view of one example embodiment of a join region of two ablation sub patterns.

### DETAILED DESCRIPTION OF THE DRAWINGS

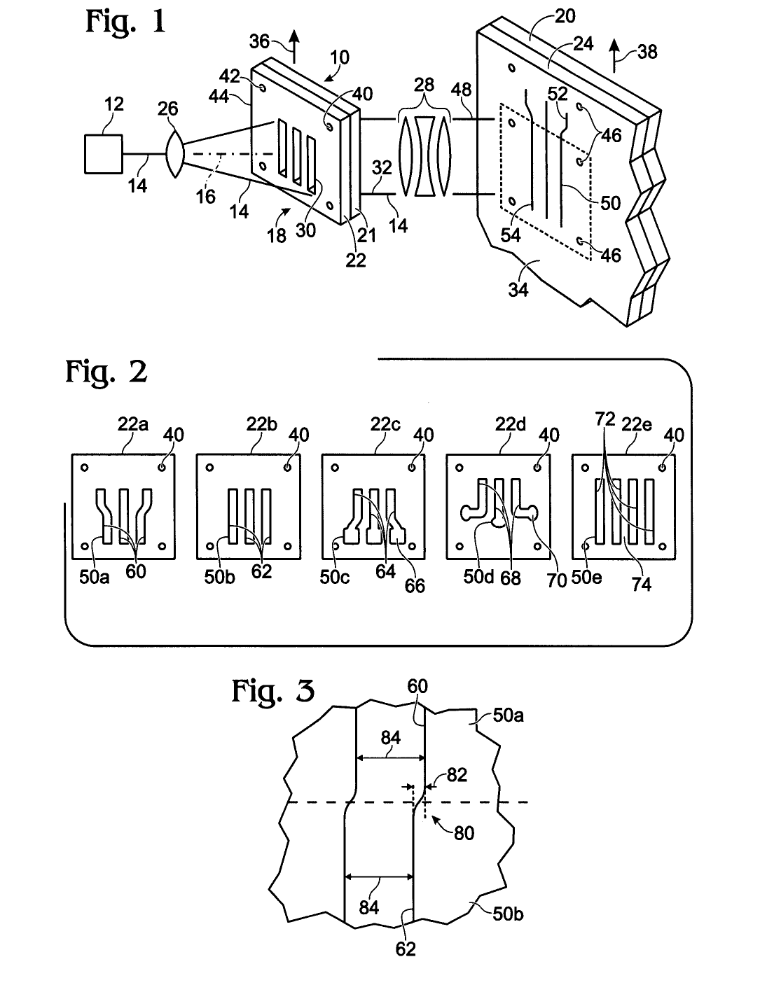

FIG. 1 is a schematic view of one example embodiment of an ablation device 10. Device 10 may include an ablation light source, such as a laser 12, that emits an ablation light 14 along a light path 16, through a mask position 18 and to a substrate support 20. A mask 22 may be removably positioned at mask position 18 on a mask holding device 21, and a substrate 24 may be removably secured on support 20. First and second optic systems 26 and 28, respectively, or other optics systems as desired, may be positioned along light path 16 to manipulate ablation light 14 as desired.

Mask 22 may define a sub pattern 30 that may allow the transmission of ablation light 14 therethrough, such that the transmitted light 32 ablates a surface 34 of substrate 24 secured on support 20. Surface 34 may be a cured film positioned on a surface of substrate 24. In one embodiment, laser 12 may remain stationary during ablation and mask 22 and substrate 24 may both be moved in a direction 36 and 38, respectively, for example, such that transmitted light 32 ablates sub pattern 30 onto surface 34 of substrate 24. Thereafter, mask 22 may be removed from mask position 18 and another mask 22b (see FIG. 2) may be positioned at mask position 18 and aligned on substrate 24. In another embodiment, 38 moves while 36 remains stationary. In another embodiment, 26 moves while 36 & 38 are stationary.

Alignment of a mask 22 with substrate 24 may be accomplished in a variety of ways, such as the use of position markers within the mask 22. In one example embodiment, mask 22 may include position markers 40, such as apertures 42 in the edge regions 44 of mask 22. Mask position markers 40 may result in the ablation of position marks, such as ablated dots 46, also referred to as fiducials, targets or datum points, on substrate 24. After removal of a mask 22, a different mask 22b (see FIG. 2) may be placed at mask position 18 such that position markers 40 may allow light to be passed through mask 22b and aligned on ablated dots 46 previously ablated on substrate 24.

In particular, the mask holding device 21 that holds the mask 22 may be adjusted and characterized so that patterns 30 from masks 22a-22e and beyond are square with respect to one another, i.e., the masks 22 are not rotated with respect to one another on a test substrate 24. The mask holding device 21 may record the positions of each individual mask 22a-22e and the like such that at a later time in the process a mask 22 may be replaced within mask holding device 21 and relocated to its prior position based on the positional information earlier recorded by mask holding device 21. In another embodiment the position of both mask 22 and substrate 24 may be manipulated until an alignment light 48, which may be low powered, non-ablation light produced by laser 12, produces light dots through the upper two apertures 42 on mask 22, wherein the light dots are aligned with the lower two ablation dots 46 produced on substrate 24 by use of the previous mask 22 positioned in mask position 18. Another embodiment may use ablation light 48 produced by laser 12 that may overlay patterns 30. After such alignment of mask 22 the ablation procedure for this newly installed mask 22 may begin such that the sub pattern 50 ablated on substrate 24 will be aligned with the sub pattern 52 previously ablated on substrate 24 to define a seamless and/or continuous pattern 54 on substrate 24. “Seamless and/or continuous pattern” may be defined as a meeting of two sub patterns wherein the meeting point or join region in the sub patterns has at most an offset of 0.5 microns. Pattern 54 may define a size larger than a size of either of sub patterns 50 or 52 standing alone. Accordingly, by aligning multiple sub patterns 50 and 52 adjacent one another on substrate 24, a large continuous pattern 54 may be ablated utilizing smaller sub patterns.

This technique allows small sub patterns to be utilized which may reduce the cost of manufacturing the sub pattern masks. Another advantage of this technique of stitching sub patterns together may allow modifications and/or changes to individual ones of the sub patterns without changing a remainder of the sub patterns. Another advantage is the situation where the length of a single pattern design may be varied for different substrates. In such a case an individual sub pattern may be repeatedly utilized a desired number of times to achieve the desired length of the resulting pattern, rather than manufacturing multiple patterns having differing lengths. For example, a flexible electronic connection substrate may be manufactured having any incremental connection line length as desired, such as 5 inches, 8 inches, 35 inches or the like, by stitching together a single sub pattern mask having a one inch length, for example, the desired number of incremental times.

As shown in FIG. 1, position markers 40 include four round apertures 42, each positioned in an edge region 44 of mask 22. In other embodiments, position markers 40 may be created having other sizes, shapes, numbers, and positions on mask 22, as may be desired for particular applications.

FIG. 2 is an isometric view of a set of ablation masks 22 each defining a sub pattern 50. Ablation mask 22a may define a sub pattern 50a including an initial or start point of three conductive line apertures 60 that after ablation may define three trenches on substrate 24 (see FIG. 1). Ablation mask 22b may define a sub pattern 50b including three straight conductive line apertures 62 that may define the same spacing and width as the lower portion of conductive line apertures 60 of sub pattern 50a. Ablation mask 22c may define a sub pattern 50c including an endpoint of three straight conductive line apertures 64 that each terminate in a connection surface region 66. The upper portion of apertures 64 may define the same spacing and width as the lower portion of conductive line apertures 62 of sub pattern 50b. Ablation mask 22d may define a sub pattern 50d including an endpoint of three straight conductive line apertures 68 that each terminate in an enlarged region 70 that may allow formation of vias on substrate 24 (see FIG. 1). The upper portion of trenches 68 may define the same spacing and width as the lower portion of conductive line apertures 62 of sub pattern 50b. Ablation mask 22e may define a sub pattern 50e including four straight line apertures 72 that may define three non-transmission regions 74, i.e., areas that do not allow light to impinge on substrate 24 (see FIG. 1), so as to define three raised line areas on substrate 24. In other embodiments other sub patterns 50 may be utilized so that substrate 24 may be ablated in any desired manner to produce any desired structure, such as a variety of microelectronic components, on substrate 24.

FIG. 3 is a top view of a join region 80 of two sub patterns 50a and 50b. Join region 80 of sub patterns 50a and 50b may be defined as seamless and/or continuous because line aperture 60 and line aperture 62 are aligned with one another and have an offset 82 of less than 0.5 microns, or an offset amount insufficient to compromise the electrical properties of an electrical component formed within apertures 60 and 62. In this embodiment, apertures 60 and 62 each have a width 84 of approximately five microns. The width 84 can range from a few hundred nanometers to several millimeters.

In one example embodiment, substrate 24 was a twelve inch diameter silicon wafer cast with SU8, which was cured immediately after casting. In another embodiment substrate 24 may be a 0.25 inch thick, twenty inch square glass plate cast with SU8, and cured immediately after casting. In another embodiment, SU8 can be laminated to flexible polymers or plastics or the pattern may be directly ablated into the substrate without SU8. Even larger substrates may be ablated using the disclosed process, such as a one meter square glass substrate or larger. Curing of the substrate immediately after casting may reduce the impact of environmental factors and may allow the ablated material to be a purchased component rather than a component prepared immediately upstream in the manufacturing flow of the process. Cured material may also be more robust than other types of substrates and may be shipped and stored with a reduced chance of an undesirable change in the substrate during shipping or storage. Another method utilizing large substrates includes using thin materials such as polymers/plastics or even thin gauged coated metal that may be put on a roll for continuous roll to roll processing via web handling devices.

In the example embodiment, the desired pattern 54 that was created was a 4.75 inch wide and eight inch long rectangle and included multiple sub patterns 50 therein. A chrome mask 22 was installed in device 10 and the substrate 24 was secured in place. The laser beam 14 that was patterned by the chrome mask 22 was a 400 micron by 62.5 mm×1 mm rectangle, which was a function of the particular optics 26 and 28 utilized. The ablation light 14 was 248 nm at 200 mj for eighty shots, to ablate the cured SU8 surface 34 of substrate 24. However, any ablative material and any appropriate wavelength, energy and shot dose may be utilized as desired for a particular application. The laser 12 was held stationary as the mask 22 was moved in direction 36 and substrate 24 was moved in direction 38. This step was repeated for multiple masks 22 to define ablation pattern 54 on substrate 24. In other embodiments, depending on the mask pattern and the desired sub pattern on the substrate, the mask and the substrate may be held stationary and the laser moved across the mask. In another embodiment, the mask and laser may be held stationary and the substrate moved to create the desired sub pattern.

Prior to ablation through each mask 22, the mask 22 is aligned by use of position markers 40 so that the sub patterns 50 are seamlessly stitched together to define an offset 82 of at most 0.5 microns. The resulting sub patterns 50 created had opening tapers and clean cut lines that are well suited for microelectronic applications. The ablated substrate may have some residue remaining thereon after the ablation process. This residue may be cleaned by a light plasma exposure or ultrasonic bath to remove the ablation residue. The post cleaning treatment is not time sensitive and may be conducted at a later time to further reduce processing costs.

The ablation apparatus and process described herein allows large patterns 54 having dimensions of greater than twelve inches on a side, for example, to be fabricated without the limitations and costs associated with photolithography processes. In particular, ablation of a cured film on a substrate offers a method of avoiding the environmental processing constraints associated with photolithographic processes, such as temperature, materials, and humidity constraints. Moreover, the ablation process described herein allows stitching together of multiple sub patterns in a large number of variations with low cost and little variation due to excursions in ambient environmental conditions. Accordingly, the ablation process as described herein may be utilized to form a large pattern of fine line circuitry for electroplating from a metallic layer underneath the ablated coating. The ablation process also allows patterning on multiple levels within substrate 24, ablation on an under layer by focusing the laser energy on such an under layer, and allows use of a wider variety of materials that may not be as sensitive to photoresist as are photolithographic materials.

Other variations and modifications of the concepts described herein may be utilized and fall within the scope of the claims below.

We claim:

1. An ablation apparatus, comprising:
a light path that defines a mask position;
a substrate support positioned along said light path downstream from said mask position;
a first mask positioned at said mask position and defining a first pattern; and
a second mask positioned at said mask position after removal of said first mask, said second mask defining a second pattern;
wherein said substrate support is moved relative to said light path during ablation such that said first and second patterns together define a continuous substrate pattern on said substrate support.

2. The apparatus of claim 1 further comprising a laser that defines a laser ablation light that travels along said light path.

3. The apparatus of claim 1 further comprising a substrate supported on said substrate support, wherein said first and second patterns together define a continuous substrate pattern on said substrate.

4. The apparatus of claim 1 wherein said substrate has a size larger than a size of said first mask and a size of said second mask combined.

5. The apparatus of claim 1 wherein said first pattern of said first mask defines a first ablation pattern on a first portion of said substrate support and wherein said second pattern of said second mask defines a second ablation pattern on a second portion of said substrate support, wherein said first and second patterns are different from one another.

6. The apparatus of claim 5 wherein said second portion of said substrate support is different from said first portion of said substrate support.

7. The apparatus of claim 1 wherein said first pattern defines a first position marker that is ablated on a substrate supported on said substrate support to define a first position mark, and wherein said second pattern defines a second position marker that is aligned with said first position mark to align said second pattern with said first pattern on said substrate.

8. The apparatus of claim 7 wherein said first and second position markers each define a series of apertures.

9. The apparatus of claim 1 further comprising a third mask positioned at said mask position after removal of said second mask, said third mask defining a third pattern, wherein said substrate support is moved relative to said light path during ablation such that said first, second and third patterns together define a continuous substrate pattern on said substrate support.

10. A method of making a microelectronic device, comprising:
ablating a first pattern on a substrate;
aligning a second pattern on said substrate such that said first and second patterns define a continuous pattern on said substrate; and
thereafter ablating said second pattern on said substrate.

11. The method of claim 10 wherein said first pattern is defined by a first mask and said second pattern is defined by a second mask.

12. The method of claim 10 wherein said ablating is conducted with a laser and wherein said substrate and laser are moved relative to one another during ablation of said first pattern and said second pattern.

13. The method of claim 10 wherein said substrate is chosen from one of a rigid substrate and a flexible substrate.

14. The method of claim 10 wherein said first and second patterns each include at least one device component chosen from the group including a connection pad, a via, a raised line, and a trench.

15. The method of claim 10 wherein said aligning said second pattern on said substrate comprises aligning a position marker of said second pattern with a position mark created during said step of ablating said first pattern on said substrate.

16. A microelectronic product including a substrate having a microstructure pattern ablated thereon, said pattern including multiple sub patterns seamlessly stitched together during ablation thereof, said product fabricated by the process comprising:
ablating a first sub pattern on a substrate;
aligning a second sub pattern on said substrate such that said first and second sub patterns define a seamless pattern on said substrate; and
thereafter ablating said second sub pattern on said substrate.

17. The product of claim 16 wherein said substrate defines a width greater than eight inches.

18. The product of claim 16 wherein said pattern includes at least three sub patterns seamlessly stitched together.

19. The product of claim 16 wherein each of said multiple sub patterns are defined by a mask that allows ablation light to pass therethrough.
